(19) United States
(12) Patent Application Publication
(10) Pub. No.: US 2019/0090064 A1
(43) Pub. Date: Mar. 21, 2019

(54) ATTACH-ON-TYPE SLIM SPEAKER FOR AUDIO DEVICES

(71) Applicant: N CITRON, INC., Seongnam-si (KR)

(72) Inventors: Soomyung KIM, Seoul (KR); Heekwon CHON, Incheon (KR)

(73) Assignee: N CITRON, INC., Seongnam-si (KR)

(21) Appl. No.: 16/122,351

(22) Filed: Sep. 5, 2018

(30) Foreign Application Priority Data
Sep. 21, 2017 (KR) 10-2017-0121792

(51) Int. Cl. H04R 9/06; H04R 9/02; H04R 7/18

(52) U.S. Cl. CPC H04R 9/06; H04R 9/025; H04R 2499/15; H04R 2400/11; H04R 7/18

(57) ABSTRACT

A speaker having a slim structure without cone paper which may be attached to an inner surface of an audio device to reproduce sound with sufficient output power is disclosed. The speaker according to the present invention comprises: a frame provided with a through-hole; a voice coil generating an electric field in response to an audio signal applied thereto; a suspension plate comprising: an edge member coupled to an upper surface of the frame along an circumference of the through-hole; a suspension member surrounded by the edge member and suspended by a connecting member connected to the edge member; and a center member surrounded by the suspension member and connected to the suspension member by a support member; a magnet disposed under the suspension plate, wherein the magnet generates a magnetic field; and a center pole having an upper end coupled to the center member, wherein the center pole is disposed in the through-hole, wherein the voice coil inserted into and coupled to the suspension member such that the voice coil vertically vibrates when the audio signal is applied.

### CROSS-REFERENCE TO RELATED PATENT APPLICATION

This non-provisional U.S. patent application claims priority under 35 U.S.C. § 119 of Korean Patent Application No. 10-2017-0121792, filed on Sep. 21, 2017, in the Korean Intellectual Property Office, the entire contents of which are hereby incorporated by reference.

### BACKGROUND OF THE INVENTION

### 1. Field

The present invention relates to a slim speaker that may be attached to an inner surface of an audio device, and more particularly, to a slim speaker without a cone paper that may be attached to an inner surface of an audio device.

### 2. Description of the Related Art

Speakers are mounted on various devices that reproduce sounds such as television (hereinafter referred to as “audio devices”), and reproduce audio signals that can be heard by the human ear. In particular, televisions have recently become slimmer, and speakers mounted on televisions are also becoming slimmer.

Korean Patent Laid-open Publication No. 10-2011-0067262 and Korean Patent Laid-open Publication No. 10-2013-0111906 disclose techniques of sliming the components of the speaker such as cone paper in order to make the speaker slimmer, However, as the slimming of the speaker progresses, achieving a speaker capable of high outputs becomes more difficult. Therefore, it is necessary to obtain a speaker capable of high outputs without sacrificing the thickness thereof.

### SUMMARY OF THE INVENTION

It is an object of the present invention to provide a slim speaker without cone paper which may be attached to an inner surface of an audio device to reproduce sound with sufficient output power.

According to one aspect of the present invention, there is provided a speaker attached to an inner surface of an audio device, comprising: a frame provided with a through-hole; a voice coil generating an electric field in response to an audio signal applied thereto; a suspension plate comprising: an edge member coupled to an upper surface of the frame along an circumference of the through-hole; a suspension member surrounded by the edge member and suspended by a connecting member connected to the edge member; and a center member surrounded by the suspension member and connected to the suspension member by a support member; a magnet disposed under the suspension plate, wherein the magnet generates a magnetic field; and a center pole having an upper end coupled to the center member, wherein the center pole is disposed in the through-hole, wherein the voice coil inserted into and coupled to the suspension member such that the voice coil vertically vibrates when the audio signal is applied.

It is preferable that the suspension member comprises guiding protrusions provided along an inner circumference thereof to guide the voice coil to be at a predetermined position.

It is preferable that an upper end of the voice coil protrudes from an upper surface of the suspension plate, and a lower end of the voice coil protrudes from a lower surface of the suspension plate into the through-hole.

The speaker may further comprise: an upper plate provided on an upper surface of the magnet and coupled to a lower end of the center pole, wherein the lower end of the voice coil is disposed in a gap between an outer circumference of the upper plate and an inner circumference of the through-hole.

The speaker may further comprise a guide ring provided at an upper end of the voice coil for an attachment to the inner surface of the audio device.

The speaker may further comprise a lower ring provided along an outer circumference of the magnet.

It is preferable that the edge member comprises a first edge member and a second edge member coupled to the upper surface of the frame along the circumference of the through-hole.

It is preferable that the connecting member comprises: a first connecting member connected to the first edge member; and a second connecting member connected to the second edge member, and the suspension member comprises: a first suspension member surrounded by the first edge member and suspended by the first connecting member; and a second suspension member surrounded by the second edge member and suspended by the second connecting member.

It is preferable that the support member comprises: a first support member connected to the first suspension member; and a second support member connected to the second suspension member, and the center member comprises: a first center member surrounded by the first suspension member and connected to the first suspension member via the first support member; and a second center member surrounded by the second suspension member and connected to the second suspension member via the second support member.

It is preferable that the first edge member and the second edge member are electrically isolated, the first connecting member and the second connecting member are electrically isolated, the first suspension member and the second suspension member are electrically isolated, the first support member and the second support member are electrically isolated, and the first center member and the second center member are electrically isolated.

It is preferable that the first edge member, the first connecting member, the first suspension member, the first support member and the first center member are electrically connected, and the second edge member, the second connecting member, the second suspension member, the second support member and the second center member are electrically connected.

It is preferable that the first edge member and the second edge member comprises a first terminal and a second terminal, whereto the audio signal is applied, respectively, and the audio signal applied to the first terminal and the second terminal are applied to the voice coil via the first edge member, the first connecting member and the first suspension member, and the second edge member, the second connecting member and the second suspension member.

### BRIEF DESCRIPTION OF THE DRAWINGS

FIGS. 1A through 1D respectively illustrate a perspective view, a top view, a bottom view and an exploded perspective view of a slim speaker according to the present invention.

FIG. 2 is a cross-sectional view of a slim speaker according to the present invention.

FIGS. 3A and 3B illustrate a suspension plate and an enlarged view of the suspension plate of a slim speaker according to the present invention, respectively.

FIGS. 4A and 4B respectively illustrate a top view and a bottom view of a main part of a slim speaker according to the present invention.

### DETAILED DESCRIPTION OF THE PREFERRED EMBODIMENTS

Hereinafter, a slim speaker according to the present invention will be described in detail with reference to the accompanying drawings.

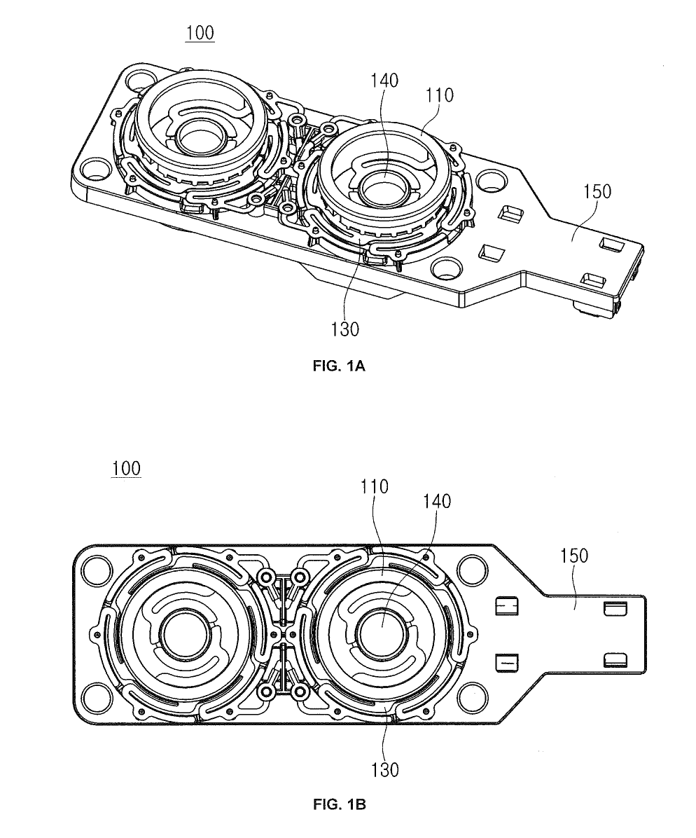

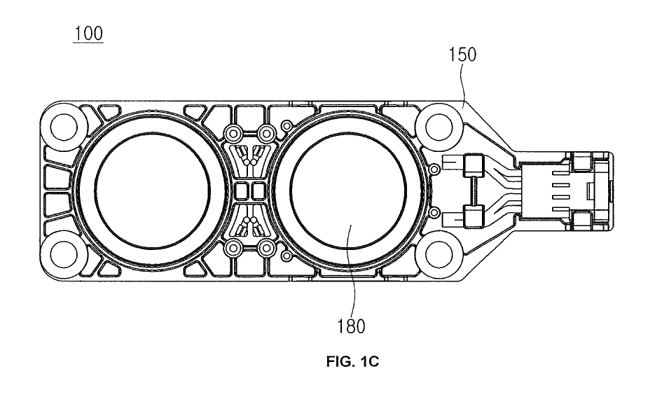

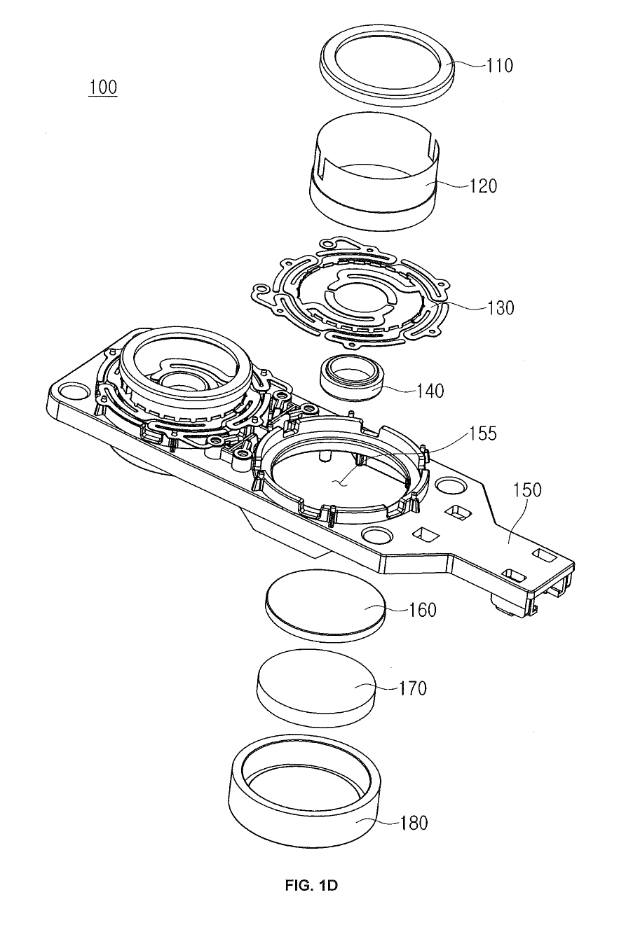

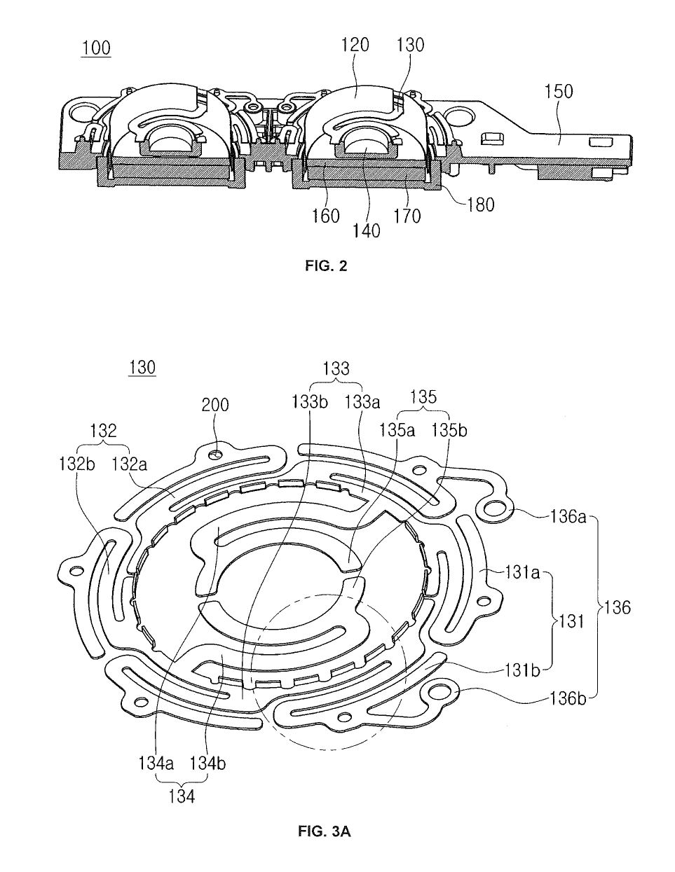

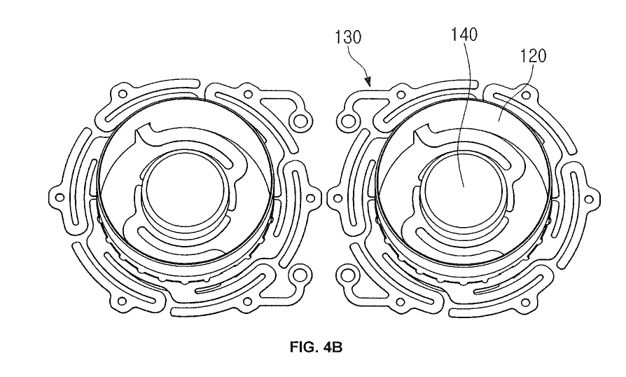

FIGS. 1A through 1D respectively illustrate a perspective view, a top view, a bottom view and an exploded perspective view of a slim speaker 100 according to the present invention, FIG. 2 is a cross-sectional view of the slim speaker 100 according to the present invention, and FIGS. 4A and 4B respectively illustrate a top view and a bottom view of a main part of the slim speaker 100 according to the present invention.

Referring to FIGS. 1A through 1D, FIG. 2 and FIGS. 4A and 4B, the slim speaker 100 according to the present invention includes a frame 150, a voice coil 120, a suspension plate 130, a magnet 170 and a center pole 140. The slim speaker 100 according to the present invention may further include an upper plate 160, a guide ring 110 and a lower ring 180.

The frame 150 has a through-hole 155. The center pole 140, a lower end of the voice coil 120 and the upper plate 160 are disposed in the through-hole 155.

The voice coil 120 is cylindrical, and inserted into and coupled to the suspension plate 130. An upper end of the voice coil 120 protrudes from the upper surface of the suspension plate 130 and the lower end of the voice coil 120 protrudes from the lower surface of the suspension plate 130 into the through-hole 155. The voice coil 120 generates an electric field in response to an audio signal applied thereto and vibrates in a vertical direction, that is, along a center axis thereof.

The suspension plate 130 includes a thin metal plate that damps the vibration of the voice coil 120. Specifically, the suspension plate 130 includes an edge member 131, a connecting member 132, a suspension member 133, a support member 134 and a center member 135.

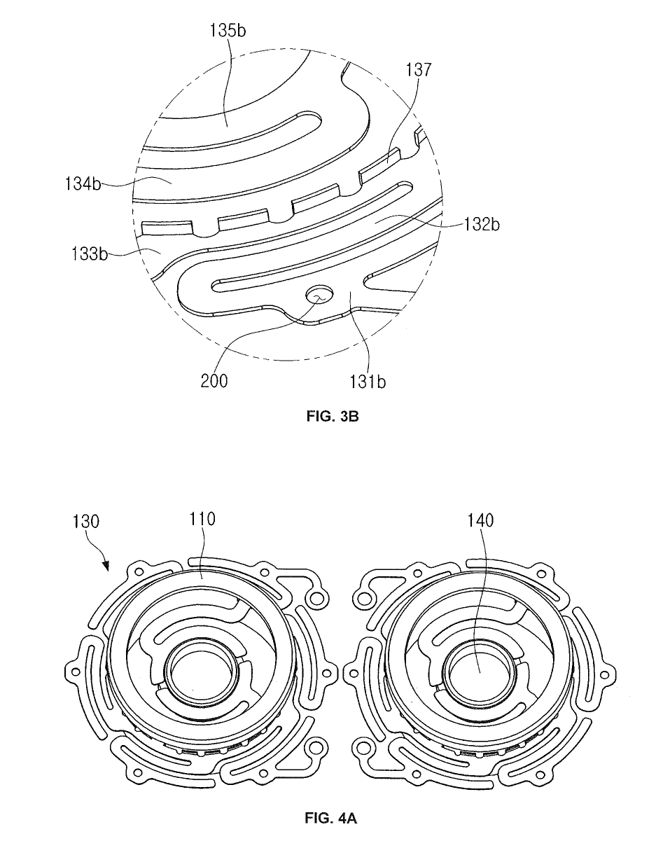

Hereinafter, the suspension plate 130 will be described in detail with reference to FIGS. 3A and 3B.

FIG. 3A illustrates the suspension plate 130 of the slim speaker 100 according to the present invention, and FIG. 3B illustrates an enlarged view of the circled portion of the suspension plate 130 shown in FIG. 3B.

Referring to FIGS. 3A and 3B, the edge member 131 extends in the circumferential direction of the through-hole 155 and is coupled to the upper surface of the frame 150 along the circumference of the through-hole 155. The edge member 131 preferably has a ring shape.

The connecting member 132 extends in the circumferential direction along the inner circumference of the edge member 131 and the first end thereof is connected to the edge member 131 from inside the edge member 131. The second end thereof is connected to the suspension member 133. The suspension member 133 is surrounded by the edge member 131 and extends in the circumferential direction along the inner circumference of the connecting member 132. The suspension member 133 is suspended by the connecting member 132, and preferably has a ring shape.

The support member 134 extends from the suspension member 133 in the circumferential direction along the inner circumference of the suspension member 133 and the first end and the second end are connected to the suspension member 133 and the center member 135, respectively. The center member 135 is surrounded by the suspension member 133 and is connected to the suspension member 133 by the support member 134. The center member 135 preferably has a ring shape.

The center member 135 is fixed by the center pole 140 and the edge member 131 is fixed to the upper surface of the frame 150 such that the suspension member 133 is suspended by the connecting member 132 and the support member 134. Since the voice coil 120 is fixed to and in contact with the inner circumference of the suspension member 133, the voice coil 120 is also suspended with the suspension member 133 and may freely vibrate in the vertical direction. In particular, as shown in FIG. 3B, the suspension member 133 may include guiding protrusions 137 along the inner circumference thereof. The guiding protrusions 137 guide and facilitate the voice coil 120 to be at a predetermined position and suppress the voice coil 120 from vibrating in the horizontal direction, i.e., the direction perpendicular to the center axis of the voice coil 120.

Hereinafter, the suspension plate 130 will be described in more detail.

As shown in FIG. 3A, the edge member 131 extends in the circumferential direction and includes a first edge member 131a and a second edge member 131b extending along the circumference of the through-hole 155 and coupled to the upper surface of the frame 150. Each of the first edge member 131a and the second edge member 131b preferably has an annulus sector shape. The first edge member 131a and the second edge member 131b are electrically isolated from each other. Each of the first edge member 131a and the second edge member 131b has a fixing hole 200. A protrusion (not shown) provided at the outer circumference of the through hole 155 is inserted into the fixing hole 200. The first edge member 131a and the second edge member 131b have a first terminal 136a and a second terminal 136b to which an audio signal is applied, respectively.

The connecting member 132 includes a first connecting member 132a and a second connecting member 132b. The first connecting member 132a and the second connecting member 132b are provided along the inner circumference of the first edge member 131a and the second edge member 131b, respectively. The first ends of the connecting members 132a and 132b are connected to the first edge member 131a and the second edge member 131a, respectively, and the second ends of the connecting members 132a and 132b are connected to a first suspension member 133a and a second suspension member 133b, respectively. The first connecting member 132a and the second connecting member 132b are electrically isolated from each other.

The suspension member 133 includes the first suspension member 133a and the second suspension member 133b. The first suspension member 133a extends in the circumferential direction and surrounded by the first edge member 131a or the first connecting member 132a. The first suspension member 133a is suspended by the first connecting member 132a. The first suspension member 133a preferably has an annular sector shape. The second suspension member 133b extends in the circumferential direction and surrounded by the second edge member 131b or the second connecting member 132b. The second suspension member 133b is suspended by the second connecting member 132b. The second suspension member 133b preferably has an annular sector shape. The first suspension member 133a and the second suspension member 133b are electrically isolated from each other.

The support member 134 includes a first support member 134a and a second support member 134b. The first support member 134a and the second support member 134b are provided along the inner circumference of the first suspension member 133a and the second suspension member 133b, respectively. The first ends of the support members 134a and 134b are connected to the first suspension member 133a and the second suspension member 133b, respectively, and the second ends of the support members 134a and 134b are connected to a first center member 135a and a second center member 135b, respectively. The first support member 134a and the second support member 134b are electrically isolated from each other.

The center member 135 includes the first center member 135a and the second center member 135b. The first center member 135a extends in the circumferential direction from the inside of the first support member 134a. The second center member 135b extends in the circumferential direction and surrounded by the first support member 134b. The first center member 135a and second center member 135b are connected to the first suspension member 133a and second suspension member 133b via the first support member 134a and the second support member 134b, respectively. Each of the first center member 135a and the second center member 135b preferably has annular sector shape. The first center member 135a and the second center member 135b are electrically isolated from each other and fixed by the center pole 140.

The first edge member 131a, the first connecting member 132a, the first suspension member 133a, the first support member 134a and the first center member 135a are electrically connected to one another, and the second edge member 131b, the second connecting member 132b, the second suspension member 133b, the second support member 134b and the second center member 135b are electrically connected to one another. Accordingly, the audio signal applied to the first terminal 136a and the second terminal 136b is transmitted to the voice coil 120 via the first edge member 131a, the first connecting member 132a and the first suspension member 133a, and the second edge member 131b, the second connecting member 132b and the second suspension member 133b.

Referring back to FIGS. 1A through 1D and 2, the magnet 170 is provided under the suspension plate 130 and generates a magnetic field. The voice coil 120 may vibrate due to the magnetic field of the magnet 170 and the electric field of the voice coil 120.

The upper end of the center pole 140 is coupled to the center member 135 and is provided in the through-hole 155. The lower end of the center pole 140 is fixed to the magnet 170 or the upper plate 160. Thus, the center member 135 is also fixed, whereby the suspension member 133 is suspended.

The slim speaker 100 according to the present invention may further include the guide ring 110. The guide ring 110 is provided at the upper end of the voice coil 120 and may be attached to the inner surface of the audio device. When the audio signal is applied to the slim speaker 100 attached to the inner surface of the audio device, the voice coil 120 moves in the direction of the center axis and the motion is transmitted through the guide ring 110 to the inner surface of the audio device by vibration. This vibration causes the audio contained in the audio signal to be reproduced. The guide ring 110 facilitates the attachment of the slim speaker 100 according to the present invention to the inner surface of the audio device. Adhesive means (not shown) such as a double-sided tape may be provided on the top surface of the guide ring 110.

The slim speaker 100 according to the present invention may further include the upper plate 160. The upper plate 160 is provided on the upper surface of the magnet 170 and is coupled to the lower end of the center pole 140. A gap is provided between the outer circumference of the upper plate 160 and the inner circumference of the through-hole 155, and the lower end of the voice coil 120 is inserted in the gap. The voice coil 120 moves in the vertical direction (about the center axis of the voice coil) within the gap.

The slim speaker 100 according to the present invention may further include the lower ring 180. The lower ring 180 is provided along the outer circumference of the magnet 170 to protect the magnet 130.

It is advantageous that the slim speaker according to the present invention has a slim structure without cone paper and may be attached to the inner surface of the audio device to reproduce the voice with sufficient output.

What is claimed is:

1. A speaker for an audio device, comprising:
a frame provided with a through-hole;
a voice coil generating an electric field in response to an audio signal applied thereto;
a suspension plate comprising: an edge member coupled to an upper surface of the frame along an circumference of the through-hole; a suspension member surrounded by the edge member and suspended by a connecting member connected to the edge member; and a center member surrounded by the suspension member and connected to the suspension member by a support member;
a magnet disposed under the suspension plate, wherein the magnet generates a magnetic field; and
a center pole having an upper end coupled to the center member, wherein the center pole is disposed in the through-hole,
wherein the voice coil inserted into and coupled to the suspension member such that the voice coil vertically vibrates when the audio signal is applied.

2. The speaker according to claim 1, wherein the suspension member comprises guiding protrusions provided along an inner circumference thereof to guide the voice coil to be at a predetermined position.

3. The speaker according to claim 1, wherein an upper end of the voice coil protrudes from an upper surface of the suspension plate, and a lower end of the voice coil protrudes from a lower surface of the suspension plate into the through-hole.

4. The speaker according to claim 3, further comprising: an upper plate provided on an upper surface of the magnet and coupled to a lower end of the center pole, wherein the lower end of the voice coil is disposed in a gap between an outer circumference of the upper plate and an inner circumference of the through-hole.

5. The speaker according to claim 1, further comprising: a guide ring provided at an upper end of the voice coil for an attachment to an inner surface of the audio device.

6. The speaker according to claim 1, further comprising: a lower ring provided along an outer circumference of the magnet.

7. The speaker according to claim 1, wherein the edge member comprises a first edge member and a second edge member coupled to the upper surface of the frame along the circumference of the through-hole.

8. The speaker according to claim 7, wherein the connecting member comprises: a first connecting member connected to the first edge member; and a second connecting member connected to the second edge member, and the suspension member comprises: a first suspension member surrounded by the first edge member and suspended by the first connecting member; and a second suspension member surrounded by the second edge member and suspended by the second connecting member.

9. The speaker according to claim 8, wherein the support member comprises: a first support member connected to the first suspension member; and a second support member connected to the second suspension member, and the center member comprises: a first center member surrounded by the first suspension member and connected to the first suspension member via the first support member; and a second center member surrounded by the second suspension member and connected to the second suspension member via the second support member.

10. The speaker according to claim 9, wherein the first edge member and the second edge member are electrically isolated, the first connecting member and the second connecting member are electrically isolated, the first suspension member and the second suspension member are electrically isolated, the first support member and the second support member are electrically isolated, and the first center member and the second center member are electrically isolated.

11. The speaker according to claim 10, wherein the first edge member, the first connecting member, the first suspension member, the first support member and the first center member are electrically connected, and the second edge member, the second connecting member, the second suspension member, the second support member and the second center member are electrically connected.

12. The speaker according to claim 11, wherein the first edge member and the second edge member comprises a first terminal and a second terminal, whereto the audio signal is applied, respectively, and the audio signal applied to the first terminal and the second terminal are applied to the voice coil via the first edge member, the first connecting member and the first suspension member, and the second edge member, the second connecting member and the second suspension member.
